(19) United States
(12) Patent Application Publication
(10) Pub. No.: US 2011/0289570 A1
(43) Pub. Date: Nov. 24, 2011

(54) SYSTEM AND METHOD FOR INTEGRATING REMOTELY ACCESSED DATA

(75) Inventors: Hai Chuan Yang, Taipei (TW); Kuen-Lin Liou, Taipei (TW); Hung-An Liang, Taipei (TW)

(73) Assignee: CHUNGHWA TELECOM CO., LTD., Taipei (TW)

(21) Appl. No.: 12/881,996

(22) Filed: Sep. 14, 2010

(30) Foreign Application Priority Data
May 18, 2010 (TW) 099115762

(51) Int. Cl. G06F 15/16; G06F 21/00; H04L 9/32

(52) U.S. Cl. 726/7; 709/219

(57) ABSTRACT

A system for integrating remotely accessed data includes a source end for providing data; a conversion device for converting the data from the source end into at least a preset format; a remote storage device for storing the data in the at least a preset format; a server connected to the remote storage device, and a user device connected to the server. A user end logs in to the server through the user device via a user account and/or password to remotely access the data in the at least a preset format stored in the remote storage device, and the remote storage device provides the data in the at least a preset format to the user device through the server, thereby integrating data of various formats into preset formats and providing preferred formats of data to various user devices so as to save costs for system configuration, increase usage efficiency of the system and increase data readability in the user devices.

### BACKGROUND OF THE INVENTION

1. Field of the Invention

The present invention relates generally to data integrating systems and methods, and, more particularly, to a system and a method for integrating remotely accessed data.

2. Description of Related Art

Along with the development of science and technology, electronic books (e-books) have been rapidly developed and are gradually replacing traditional paper-based books. Since the e-books are convenient and functional, the applications for e-books have become more and more diverse.

One application involves borrowing and reading of e-books online in a digital library. Users can borrow and read the e-books online through a database system of the library or download the e-books from the database system for reading. Compared with traditional paper-based books, e-books are easier to store, transfer or update, not limited by physical space constraints, can contain sounds and/or images and can be interactive. However, e-books are unlikely to completely replace or play the same role as paper-based books within a short time. One of the reasons is a lack of digital content in e-book form. For example, catalogs of e-books published in the market and/or circulated in libraries are often quite different from those of paper-based books, especially for Chinese e-books and paper-based books. As such, many libraries have hardware devices but lack digital data.

Currently, in that there is no uniform international, national or industry standard for a sole e-book format, e-books are published in different formats by different digital publishers. As such, specific hardware and software or compatible electronic readers are required for reading e-books in different formats, and various database systems need to be built for storage of the e-books in different formats, thereby increasing costs and lowering users' willingness to adopt e-books.

In particular, the above-described drawbacks increase the difficulty for teachers in schools in editing, transferring and/or using digital content such as e-books and multimedia teaching materials and also increase the difficulty for students in data accessing, reading, learning and/or interaction, thereby limiting the development of digital environments in schools. Therefore, it is imperative to provide a method and a system for integrating remotely accessed data, through which various formats of data can be integrated to preset formats and stored in a remote storage device such that preferred formats of data can be provided according to different user devices, thereby saving costs and increasing the usage efficiency of the system and data readability of the user devices.

### SUMMARY OF THE INVENTION

In view of the above drawbacks of the prior art, the present invention provides a method for integrating remotely accessed data, which comprises the steps of: providing data by a source end; a conversion device converting the data from the source end into at least a preset format; storing the data in the at least a preset format in a remote storage device; having a user end log in to a server through a user device via a user account and/or password; having the user device remotely access the data in the at least a preset format stored in the remote storage device through the server; and providing the data in the at least a preset format by the remote storage device to the user device through the server.

The present invention further provides a system for integrating remotely accessed data, which comprises: a source end for providing data; a conversion device for converting the data from the source end into at least a preset format; a remote storage device for storing the data in the at least a preset format; a server connected to the remote storage device; and a user device connected to the server, wherein a user end logs in to the server through the user device via a user account and/or password in a configured way, the user device remotely accesses the data in the at least a preset format stored in the remote storage device through the server, and the remote storage device provides the data with the preset format to the user device through the server.

Therefore, based on distributed computing through a remote network, the present invention integrates data of various formats into preset formats through a conversion device, stores the data with the preset formats in a remote storage device and provides preferred formats of data to various user devices so as to save costs for system configuration and increase usage efficiency of the system and data readability of the user devices.

### BRIEF DESCRIPTION OF DRAWINGS

FIG. 1 is a block diagram showing the structure of a system for integrating remotely accessed data according to the present invention; and

FIG. 2 is a flow diagram showing a method for integrating remotely accessed data according to the present invention.

### DETAILED DESCRIPTION OF PREFERRED EMBODIMENTS

The following illustrative embodiments are provided to illustrate the disclosure of the present invention and its advantages, these and other advantages and effects being apparent to those in the art after reading this specification.

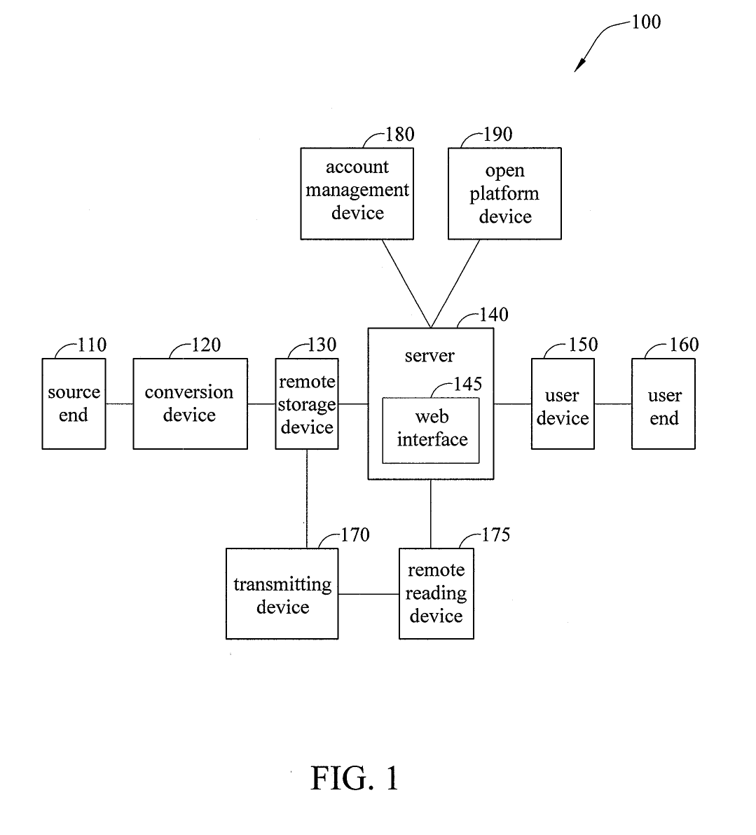

FIG. 1 is a block diagram showing the structure of a system 100 for integrating remotely accessed data according to an embodiment of the present invention.

Referring to FIG. 1, the system 100 is built over a network and comprises a source end 110, a conversion device 120, a remote storage device 130, a server 140, a user device 150 and a user end 160. Therein, the network can be the Internet, an extranet and/or an intranet, but it is not limited thereto.

The source end 110 provides data, for example e-books and/or digital teaching materials with digital content, e.g., characters, symbols, sounds and/or images. The e-books may be provided by digital publishers, governments, schools and/or individuals (e.g. teachers or students) and so on. The digital teaching materials may be teaching materials (presentation files or animated short films) provided by teachers or other materials with digital content, including characters, symbols, sounds and/or images (e.g. news databases or static dynamic image file databases).

The conversion device 120 is connected to the source end 110 for accessing data from the source end 110 and converting the accessed data into a plurality of preset formats. The preset formats can be HTML, PDF, FLASH, WORD, PPT and/or E-PUB, but are not limited thereto.

The remote storage device 130 is connected to the conversion device 120 for storing the data with the preset formats. The remote storage device 130 can be a server which supports distributed computing through a remote network. The remote storage device 130 can comprise a single server or a plurality of servers and can be a storage device using cloud-computing techniques. In particular, if the remote storage device 130 is built and managed by a school or an enterprise or built and managed by a cloud-computing service system provider for the school or enterprise, it is a private cloud. On the other hand, if the remote storage device 130 belongs to a public service provided by a third party, it is a public cloud. In an embodiment, if a plurality of remote storage devices 130 is provided, the private cloud and the public cloud can be integrated together to provide data access services.

The server 140 is connected to the remote storage device 130, and has a web interface 145 used for the user end 160 to log in to the server 140 through the user device 150 via a user account and/or password so as to access the data stored in the remote storage device 130.

The user device 150 is connected to the server 140 and the user end 160 is connected to the user device 150. The user device 150 can be an electronic communications device such as a desktop computer, a notebook computer, a mobile phone and/or an electronic reader, but it is not limited thereto.

Preferably, the system 100 further comprises a transmitting device 170 connected to the remote storage device 130.

In addition, the system 100 further comprises a remote reading device 175 connected to the transmitting device 170 and the server 140, wherein the data stored in the remote storage device 130 can further be stored in the remote reading device 175, and the remote reading device 175 can further store data access records of the user end 160 so as to rapidly perform data access in the case of accessing the same data.

Furthermore, the system 100 can comprise an account management device 180 and an open platform device 190 connected to the server 140.

The account management device 180 is connected to the server 140, and used for authenticating the user account and/or password and storing account management data at least comprising the user account and/or password. In addition, the system 100 can comprise a small payment module (not shown), which makes small payments with cash, bonus points, credit cards or charges to phone bills according to the user account and/or password.

The open platform device 190 is connected to the server 140 and comprises an editing module such that the user end 160 can log in to the open platform device 190 through the user device 150 so as to edit data and provide the edited data to the source end 110. In particular, electronic teaching materials can be edited online or offline by teachers through the editing module, stored in the source end 110, converted by the conversion device 120 to preset formats and further stored in the remote storage device 130. Thereby, students can log in to the open platform device 190 to online read and/or completely download the teaching materials.

Further, in the case that the open platform device 190 is a teaching platform, it can further comprise an online test module, a learning assessment module and a community interactive module (not shown).

Students can log in to the teaching platform either in class or at home so as to take an online test through the online test module, and the learning assessment module can calculate test scores, give detailed explanations of test questions and analyze test results so as to make recommendations for students' progression. Further, the learning assessment module can record learning notes for regular reading of teaching materials by students. Furthermore, the community interactive module allows teachers, students or parents to participate in discussion and post comments through a forum thereof and also can modify discussion contents of other users.

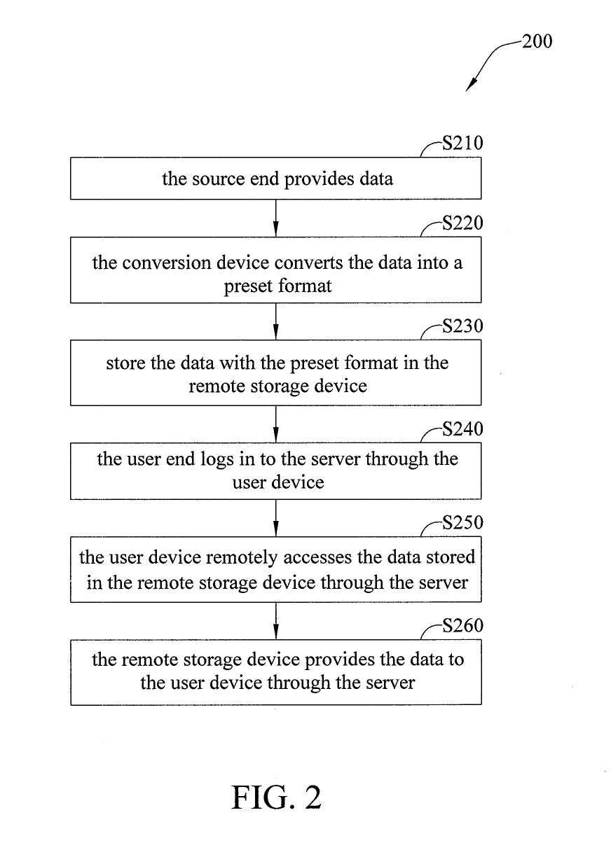

Referring to FIG. 2 (also referring to FIG. 1), a method 200 for integrating remotely accessed data according to an embodiment of the present invention is shown. The user end 160 performs the following steps in a configured way.

As shown in FIG. 2, at step S210, the source end 110 provides data. Then, the process goes to step S220.

At step S220, the conversion device 120 converts data into one or more formats from a plurality of preset formats. Then, the process goes to step S230.

Preferably, after step S220, the data in the preset format can be selectively converted so as to have a digital rights management (DRM) mechanism, thereby protecting property rights of authors.

Further, after step S220, the data in the preset format can be selectively converted so as to have tags, thereby facilitating subsequent management and use of the data on the user end 160.

At step S230, the data in the preset formats are stored in the remote storage device 130. Then, the process goes to step S240.

At step S240, the user end 160 logs in to the server 140 through the user device 150 via a user account and/or password. Then, the process goes to step S250.

Preferably, at step S240, the user device 150 can log in to the server 140 via the web interface 145 by using the user account and/or password and in a wired way and/or in a wireless way such as, but not limited to, WiFi and 3G.

Preferably, after step S240, the account management device 180 authenticates the user account and/or password and stores account management data at least comprising the user account and/or password. Preferably, the account management device 180 can selectively manage payment or points of the user end 160 by using the account management data, but it is not limited thereto.

Preferably, after step S240, the user end 160 can be connected to the open platform device 190 through the server 140 so as to access a plurality of services. The plurality of services can be third-party added value services such as online tests, library exercise services, learning assessment services and/or community interactive platforms, but they are not limited thereto.

At step S250, the user device 150 remotely accesses the data stored in the remote storage device 130 through the server 140. Then, the process goes to step S260.

At step S260, the remote storage device 130 provides the data in the preset formats to be accessed by the user device 150 through the server 140 to the user device 150.

Preferably, in step S260, the remote storage device 130 can selectively provide the data via the transmitting device 170 through the server 140 to the user device 150. Therein, the transmitting device 170 determines the preset formats of the data to be provided to the user device 150 according to the type of the user device 150 and provides preferred screen formats according to the screen specification of the user device 150. For example, if the user device 150 is a desktop computer or a notebook computer, the transmitting device 170 provides the data in the PDF format or FLASH format to the user device 150 and provides the preferred displaying format according to the screen specifications of the desktop computer or the notebook computer.

Further, preferably, the remote storage device 130 can selectively provide the data with the preset formats to the user device 150 via the transmitting device 170, the remote reading device 175 and the server 140. Therein, the data are stored in the remote reading device 175 so as for the user end 160 to read on the user device 150. In addition, the remote reading device 175 can store data access records of the user end 160 so as to rapidly perform data access in the case of accessing the same data.

A method and a system for integrating remotely accessed data according to an embodiment of the present invention are detailed as follows. But it should be noted that the present invention is not limited thereto.

As described above, the method and system for integrating remotely accessed data are applied in a digital library of a campus or government agency. The following embodiment exemplifies a campus digital library, but it is not limited thereto.

First, the digital library accesses data such as e-books published by digital publishers or digital teaching materials edited by teachers from the source end 110. Since the original data have various formats, the conversion device 120 converts the data into preset formats such as HTML, PDF, FLASH, WORD, PPT and/or E-PUB.

In addition, to protect property rights of authors, the data with the preset formats are converted so as to have a digital right property mechanism. Further, the data in the preset formats can be converted so as to have tags. The tags can be file tags, content tags, semantic tags and so on. Further, the data with the tags are stored in the remote storage device 130 so as for the user end 160 to remotely access.

When the user end 160, such as a student, a teacher or a parent, uses the user device 150 such as a desktop computer, a notebook computer, a mobile phone or an electronic reader to log in to the server 140 of the campus library via the web interface 145 by using a user account and/or password and in a wireless way such as WiFi or 3G, the server 140 authenticates the user account/password by using the campus account management system 180. Then, the user end 160 can remotely access data through the server 140 of the campus library.

To borrow e-books or read digital teaching materials, the user end 160 accesses the data stored in the remote storage device 130 through the server 140 of the campus library and the remote storage device 130 provides the data with at least one of the preset formats to the user device 150 through the transmitting device 170, the remote reading device 175 and the server 140. Therein, the transmitting device 170 determines the preset formats of the data to be provided to the user device 150 according to the type of the user device 150 and provides preferred screen formats according to the screen specification of the user device 150.

Further, if the library requires payment for borrowing or reading the data, the campus account management system 180 can provide payment or points. Further, the user end 160 can be connected to the open platform device 190 through the server 140 so as to access other services such as exercise library services, learning assessment services, community notes, teacher/student creations, parent-student sharing and so on.

Therefore, based on distributed computing through a remote network, the present invention integrates data of various formats into preset formats through a conversion device, stores the data with the preset formats in a remote storage device and provides preferred formats of data to various user devices so as to save costs for system configuration and increase usage efficiency of the system and data readability of the user devices.

The above-described descriptions of the detailed embodiments are provided to illustrate the preferred implementation according to the present invention, and are not intended to limit the scope of the present invention. Accordingly, many modifications and variations completed by those with ordinary skill in the art can be made and yet still fall within the scope of present invention as defined by the appended claims.

What is claimed is:

1. A method for integrating remotely accessed data, comprising the steps of:
providing data by a source end;
converting by a conversion device the data from the source end into at least a preset format;
storing the data in the at least a preset format in a remote storage device;
having a user end log in to a server through a user device via a user account and/or password;
having the user device remotely access the data in the at least a preset format stored in the remote storage device through the server; and
providing the data in the at least a preset format by the remote storage device to the user device through the server.

2. The method of claim 1, further comprising, after the step of converting the data into at least a preset format by the conversion device, converting the data in the at least a preset format to have a digital rights management mechanism.

3. The method of claim 1, further comprising, after the step of converting the data into at least a preset format by the conversion device, converting the data in the at least a preset format to have tags.

4. The method of claim 1, wherein the remote storage device provides the data in the at least a preset format via a transmitting device through the server to the user device.

5. The method of claim 4, wherein the transmitting device determines the at least a preset format of the data to be provided to the user device according to type of the user device.

6. The method of claim 4, wherein the remote storage device provides the data in the at least a preset format via the transmitting device and a remote reading device through the server to the user device.

7. The method of claim 6, wherein the data in the at least a preset format is stored in the remote reading device.

8. The method of claim 1, wherein the user device is a desktop computer, a notebook computer, a mobile phone and/or an electronic reader.

9. The method of claim 1, wherein the data comprises e-books and/or teaching materials.

10. The method of claim 1, wherein the at least a preset format is HTML, PDF, FLASH, WORD, PPT and/or E-PUB.

11. The method of claim 1, wherein the user device logs in to the server via a web interface by using the user account and/or password and through a wired and/or wireless way.

12. The method of claim 1, further comprising, after the step of having the user end log in to the server through the user device via a user account and/or password, authenticating the user account and/or password by an account management device, and storing account management data through the account management device.

13. The method of claim 12, wherein the account management device manages payments or points by using the account management data.

14. The method of claim 1, further comprising, after the step of having the user end log in to the server through the user device via a user account and/or password, connecting the user end to an open platform device through the server so as to access services provided by the open platform device.

15. A system for integrating remotely accessed data, comprising:
a source end for providing data;
a conversion device for converting the data from the source end into at least a preset format;
a remote storage device for storing the data in the at least a preset format;
a server connected to the remote storage device; and
a user device connected to the server,
wherein a user end logs in to the server through the user device via a user account and/or password in a configured way, the user device remotely accesses the data in the at least a preset format stored in the remote storage device through the server, and the remote storage device provides the data in the at least a preset format to the user device through the server.

16. The system of claim 15, further comprising a transmitting device connected to the remote storage device such that the remote storage device provides the data in the at least a preset format via the transmitting device through the server to the user device.

17. The system of claim 16, wherein the transmitting device determines the at least a preset format of the data to be provided to the user device according to type of the user device.

18. The system of claim 16, further comprising a remote reading device connected to the transmitting device and the server such that the remote storage device provides the data in the at least a preset format via the transmitting device and the remote reading device through the server to the user device.

19. The system of claim 18, wherein the data in the at least a preset format is stored in the remote reading device.

20. The system of claim 15, wherein the user device is a desktop computer, a notebook computer, a mobile phone and/or an electronic reader.

21. The system of claim 15, wherein the data are e-books and/or teaching materials.

22. The system of claim 15, wherein the at least a preset format is HTML, PDF, FLASH, WORD, PPT and/or E-PUB.

23. The system of claim 15, further comprising an account management device connected to the server and used for authenticating the user account and/or password and storing account management data at least comprising the user account and/or password.

24. The system of claim 23, further comprising a small payment module for managing payments or points according to the account management data.

25. The system of claim 15, further comprising an open platform device connected to the server for providing services.

26. The system of claim 25, wherein the open platform device comprises an editing module, which allows the user end that logs in to the open platform device through the user device to edit data and provide the data to the source end.

27. The system of claim 25, wherein the open platform device comprises:
an online test module which allows the user end logging in to the open platform device to perform an online test;
a learning assessment module which allows the user end logging in to the open platform device to execute learning tasks and assesses learning by uploading questions, answers and/or notes; and
a community interactive module which allows a plurality of the user ends logging in to the open platform device to participate in discussion and modifies uploaded discussion contents of the user ends.

28. The system of claim 15, wherein the remote storage device comprises a single server or a plurality of servers.

29. The system of claim 15, wherein the remote storage device is a storage device using cloud computing.

30. The system of claim 29, wherein the remote storage device uses at least one of private cloud computing and public cloud computing.
